(19) United States
(12) Patent Application Publication
(10) Pub. No.: US 2006/0173669 A1
(43) Pub. Date: Aug. 3, 2006

(54) Process model consolidation

(76) Inventors: Alexander Dreiling, Paddington (AU); Michael Rosemann, Windsor (AU); Karsten A. Schulz, Middle Park (AU); Wasim Sadiq, Westlake (AU)

Correspondence Address: PERKINS COIE LLP, 101 JEFFERSON DR, PO BOX 2168, MENLO PARK, CA, 94025, US

(21) Appl. No.: 11/026,382

(22) Filed: Dec. 30, 2004

(51) Int. Cl. G06F 9/45

(52) U.S. Cl. 703/22

(57) ABSTRACT

A computer-implemented method for creating a consolidating model includes converting a plurality of network specific models into a plurality of network common models wherein the plurality of network common models has a common granularity level and common technical terms. A consolidated model skeleton is then created based on the plurality of network common models wherein the consolidated model skeleton includes one or more common functions from each network specific model of the plurality of network specific models. Finally, unconnected functions in the consolidated model skeleton are connected with a branched function.

### DESCRIPTION OF THE RELATED ART

Process configuration for contemporary enterprise systems is a major task given the amount of business processes that these systems target and their rich functionality. Especially in large corporations, however, different parts of the organization may require for configuring processes differently. This may result from geographical dispersion and the resulting necessity for obtaining different national laws, different parts policies in different parts of the organization or the management structure in the organization. In a scenario where different parts of the organization can freely configure their parts of an enterprise system, and also with the business processes of the enterprise system, it is no longer possible to look at generalized business processes from an “organization as a whole” perspective. Thus, there exists no consistent support for a consolidated view on business process management from the perspective of the entire organization.

For example, an organization may primarily exist of three subunits—each located in different countries. To perform a business process, such as invoice processing, each subunit has a need to configure the software-supported generalized process to meet their own needs. These needs can include abiding by local law, conforming to subunit management preferences and responding to customer requirements. As a result, each subunit has their own unique process. To provide consistent process related guidance for all three subunits, the challenge lies in how to merge those three processes into one single process model yet still allow for the requirements of each subunit.

One option for merging these similar, yet disparate, processes is to re-code a brand new singular process for all of the subunits. This approach would typically involve a team of programmers and stakeholders to plan the project, execute the project and finally provide support after installation. Obviously, this could be a very expensive option and time-consuming operation. Additionally, once the project is completed, any new requirements would most likely require even more time and money to implement.

Yet another possible alternative is to implement an entirely new system. This option would also be rather time-intensive and most certainly expensive. As a result, this path is also not so desirable.

In view of the foregoing, it may be useful to provide methods and systems that facilitate process consolidation of varying aspects of an organization while still allowing for customization to meet the needs of those varying aspects of the organization.

### SUMMARY OF EMBODIMENTS OF THE INVENTION

The present invention is described and illustrated in conjunction with systems, tools and methods of varying scope which are meant to be exemplary and illustrative, not limiting in scope.

A computer-implemented method for consolidating models, in accordance with an exemplary embodiment, includes converting a plurality of network specific models into a plurality of network common models wherein the plurality of network common models has a common granularity level and common technical terms. A consolidated model skeleton is then created based on the plurality of network common models wherein the consolidated model skeleton includes one or more common functions from each network specific model of the plurality of network specific models. Finally, unconnected functions in the consolidated model skeleton are connected with a branched function.

A computer-implemented method for consolidating models, in accordance with another exemplary embodiment, includes converting a plurality of network specific models into a plurality of network common models wherein the plurality of network common models has a common granularity level and common technical terms wherein a compiler converts a network specific model of the plurality of network specific models to the common granularity level if a granularity level of the network specific model is coarser than the common granularity level, and wherein a decompiler converts a network specific model of the plurality of network specific models to the common granularity level if a granularity level of the network specific model is finer than the common granularity level. A consolidated model skeleton is then created based on the plurality of network common models wherein the consolidated model skeleton includes one or more common functions from each network specific model of the plurality of network specific models. Finally, unconnected functions in the consolidated model skeleton are connected with a branched function.

In addition to the aspects and embodiments of the present invention described in this summary, further aspects and embodiments of the invention will become apparent by reference to the drawings and by reading the detailed description that follows.

### BRIEF DESCRIPTION OF THE DRAWINGS

FIG. 1 is a block diagram illustrating a network communication system;

FIG. 2 is a flowchart illustrating a method for process consolidation, in accordance with an exemplary embodiment;

FIG. 3 is a block diagram further illustrating the model conversion process of FIG. 2, in accordance with an exemplary embodiment;

FIG. 4A is an exemplary block diagram further illustrating the process of creating the consolidated model skeleton of FIG. 2, in accordance with an exemplary embodiment;

FIG. 4B is an exemplary block diagram further illustrating the process of connecting the unconnected functions of the consolidated model skeleton of FIG. 2, in accordance with an exemplary embodiment;

FIG. 5A is another exemplary block diagram further illustrating the process of creating the consolidated model skeleton of FIG. 2, in accordance with an exemplary embodiment; and

FIG. 5B is another exemplary block diagram further illustrating the process of connecting the unconnected functions of the consolidated model skeleton of FIG. 2, in accordance with an exemplary embodiment.

### DETAILED DESCRIPTION

An aspect of the present invention contemplates methods and systems for process consolidation. Varying models that characterize the differing operations of an organization are converted to an integrated model. Common processes of the converted models are identified and a new model is constructed based on the common processes. Non-common processes are then incorporated to allow for customization for the differing operations of the organization. Advantageously, aspects of the present invention enables implementation of an organization-wide ERP software system yet still allow for customization for various subunits. As a result, an organization can efficiently implement ERP software and still meets the needs of the various subunits. Moreover, it supports a centralized and integrated view on the various ways of operation.

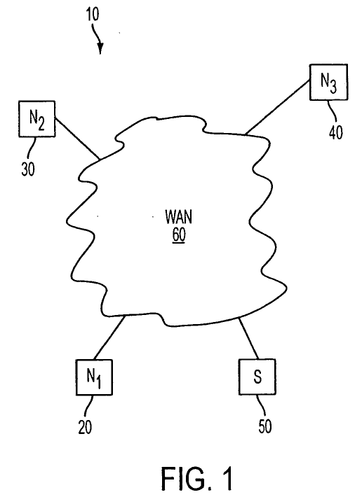

FIG. 1 is a block diagram illustrating a network communication system 10. Included in system 10 are various networks N₁ 20, N₂ 30 and N₃ 40, and a server 50, all of which can communicate with each other over wide area network (“WAN”) 60. Networks N₁ 20, N₂ 30 and N₃ 40 typically house the operations of varying aspects of an organization. These varying aspects can perhaps represents different geographic locations, business units or divisions of the organization. Server 50 typically performs processes that are common to the entire organization, for example email.

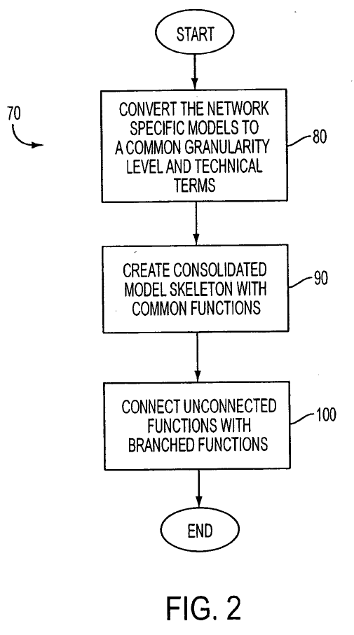

FIG. 2 is a flowchart illustrating a method 70 for process consolidation, in accordance with an exemplary embodiment. After a start operation, network specific models are converted to a common granularity level and varying technical terms are also converted to standard terminology, at an operation 80. The network specific models represent the customized processes of the varying aspects of the organization of essentially the same generic business process, for example procurement. At operation 90, a consolidated model skeleton is created based on functions that are common to all of the converted models. Finally, at an operation 100, any remaining functions that are not common to the converted models are added in and connected as branched functions. As a result, a single model is created that can be used by the entire organization, yet still provide varying levels of customization for different parts of the organization.

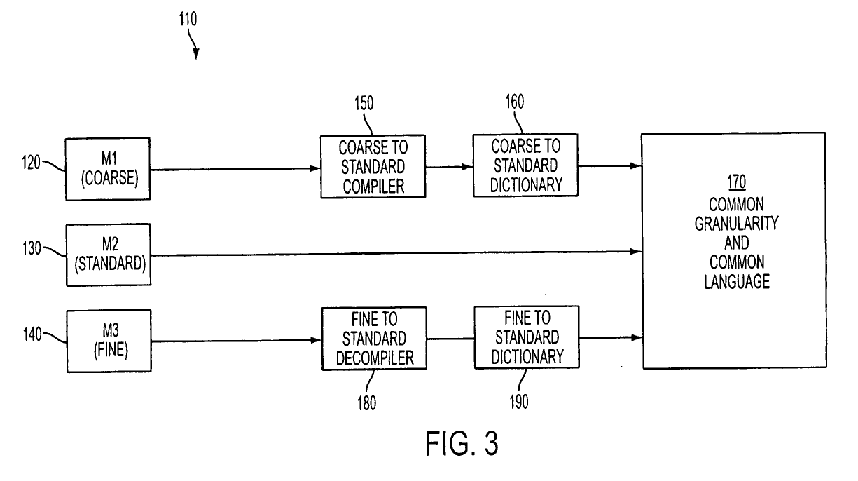

FIG. 3 is a block diagram 110 further illustrating the model conversion process 80 of FIG. 2, in accordance with an exemplary embodiment. Included in block diagram 110 are models of varying granularity levels. Model M₁ 120 has a coarse granularity, model M₂ 130 has a standard granularity level and model M₃ 140 has a fine granularity level. Since all the models need to be converted to the same granularity level, only those models that are not standard need to be converted. It should be noted that the only requirement is that the models all have the same granularity level and as such any one particular granularity level can be labeled as ‘standard’. In the block diagram 110, a granularity level in between coarse and fine has been selected as the standard granularity level. However, the coarse and fine granularity levels and other varying levels of granularity could also be the standard.

To convert M₁ 120 to the standard granularity, it is processed through a coarse to standard compiler 150. The converted model is then processed through a coarse to standard dictionary 160 so that the converted model 170 will have a common set of technical terms. In a similar manner, M₃ 140 is processed through a fine to standard decompiler 180 and a fine to standard dictionary 190.

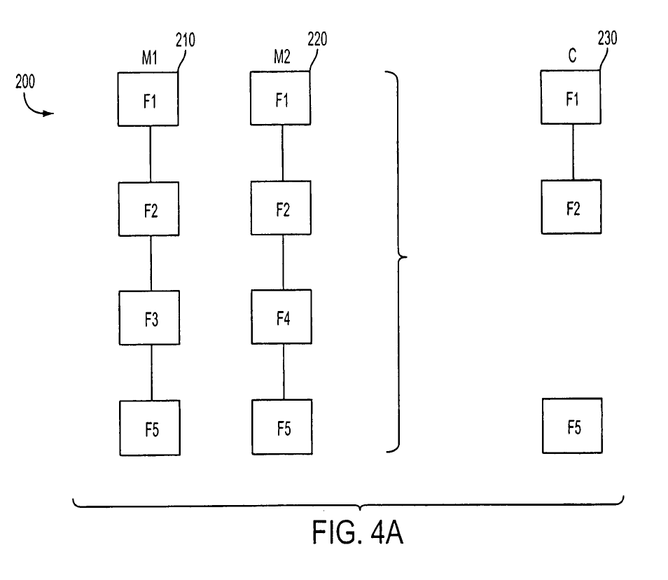

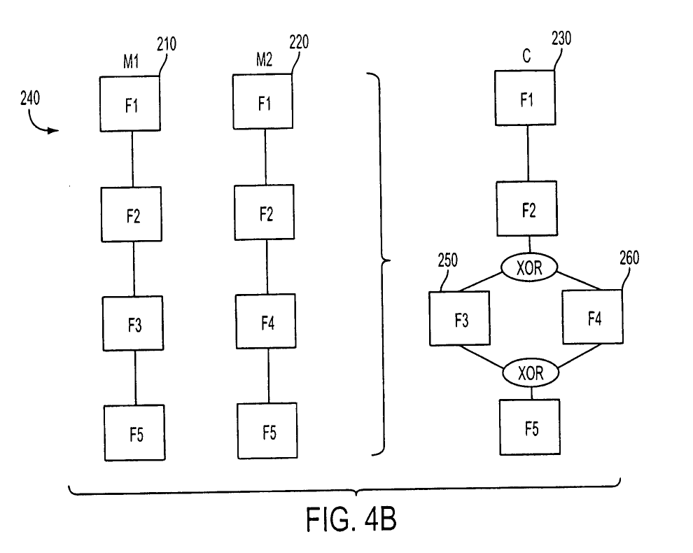

FIG. 4A is an exemplary block diagram 200 further illustrating the process 90 of creating the consolidated model skeleton of FIG. 2, in accordance with an exemplary embodiment. Included in block diagram 200 are converted models M₁ 210 and M₂ 220. Model M₁ 210 contains functions F1, F2, F3 and F5. Model M₂ 220 contains a slightly different set of functions—F1, F2, F4 and F5. A consolidated model skeleton 230 is therefore created from the functions common to both models M₁ 210 and M₂ 220—F1, F2 and F5. To complete the consolidated model skeleton 230, functions F3 and F4 need to be incorporated.

FIG. 4B is an exemplary block diagram 230 further illustrating the process 100 of connecting the unconnected functions of the consolidated model skeleton of FIG. 2, in accordance with an exemplary embodiment. As previously indicated by the consolidated model skeleton 230 of FIG. 4A, functions common to both models M₁ 210 and M₂ 220 were first used as a starting point. Now that they have been added, functions unique to each of the models M₁ 210 and M₂ 220 need to be incorporated. In this particular example, function F3 of model M₁ 210 and function F4 of M₂ 220 are the functions that make the models unique. Functions F3 and F4 are therefore incorporated into consolidated model skeleton 230 as branched functions 250 and 260. By implementing the branched functions 250 and 260, one consolidated model can be employed yet still retain the uniqueness of models M₁ 210 and M₂ 220. For example, if the process of model M₁ 210 needs to be performed, then branched function 250 will be employed, after functions F1 and F2 are completed. Similarly, if the process of model M₂ 220 is desired, then branched function 260 will be used, after functions F1 and F2 are completed.

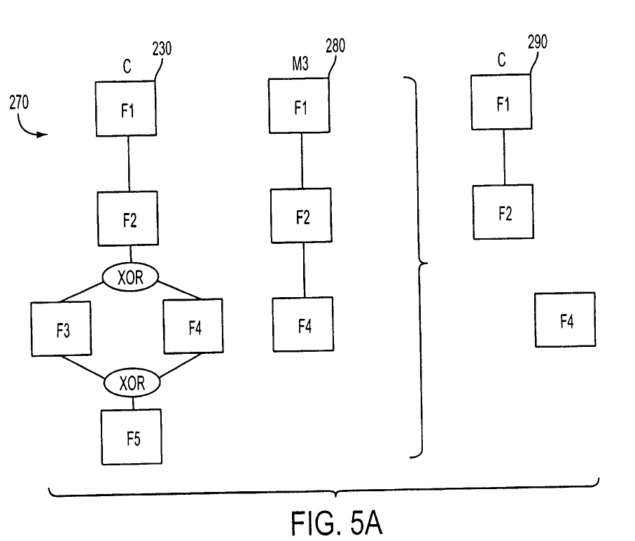

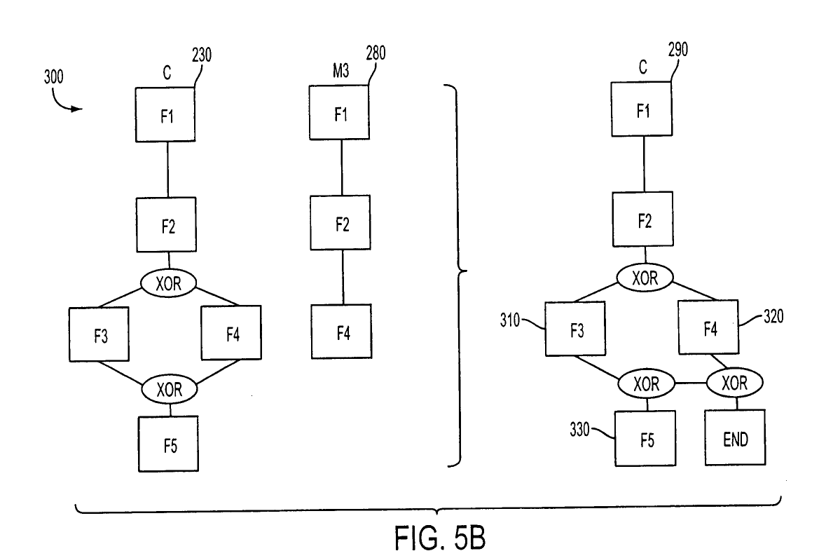

FIG. 5A is another exemplary block diagram 270 further illustrating the process 90 of creating the consolidated model skeleton of FIG. 2, in accordance with an exemplary embodiment. In this particular example, it is desired to merge another model M₃ 280 into consolidated model skeleton 230. To achieve this, the common functions are laid out into a new consolidated model skeleton 290. The functions common to skeleton 230 and model M₃ 280 are F1, F2 and F4.

FIG. 5B is another exemplary block diagram further illustrating the process of connecting the unconnected functions of the consolidated model skeleton of FIG. 2, in accordance with an exemplary embodiment. After the common functions have been identified and incorporated into consolidated process skeleton 290, the balance of the functions need to be added—F3, F4 and F5. To achieve the functionality of consolidated process skeleton 230 and model M₃ 280 in consolidated model skeleton 290, functions F3, F4 and F5 are added in as branched functions 310, 320 and 330. Consolidated process skeleton 290 now has the individual functionality of all three models (M₁ 210, M₂ 220 and M₃ 280) in one consolidated model.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

What is claimed is:

1. A computer-implemented method for consolidating models comprising:
converting a plurality of network specific models into a plurality of network common models wherein the plurality of network common models has a common granularity level and common technical terms;
creating a consolidated model skeleton based on the plurality of network common models wherein the consolidated model skeleton includes one or more common functions from each network specific model of the plurality of network specific models; and
connecting unconnected functions in the consolidated model skeleton with a branched function.

2. The computer-implemented method as recited in claim 1 wherein an individual network specific model of the plurality of network specific models has a granularity level that can be a coarse granularity level, a standard granularity level or a fine granularity level.

3. The computer-implemented method as recited in claim 2 wherein the common granularity level is the coarse granularity level, the standard granularity level or the fine granularity level.

4. The computer-implemented method as recited in claim 2 wherein the common granularity level is the standard granularity level.

5. The computer-implemented method as recited in claim 4 wherein each network specific model of the plurality of network specific models that has the coarse granularity level is converted to a network common model of the plurality of network common models via a coarse to standard compiler.

6. The computer-implemented method as recited in claim 5 wherein a coarse to standard dictionary converts one or more coarse technical terms into the common technical terms.

7. The computer-implemented method as recited in claim 4 wherein each network specific model of the plurality of network specific models that has the fine granularity level is converted to a network common model of the plurality of network common models via a fine to standard decompiler.

8. The computer-implemented method as recited in claim 7 wherein a fine to standard dictionary converts one or more fine technical terms into the common technical terms.

9. The computer-implemented method as recited in claim 2 wherein the common granularity level is the fine granularity level.

10. The computer-implemented method as recited in claim 9 wherein each network specific model of the plurality of network specific models that has the coarse granularity level is converted to a network common model of the plurality of network common models via a coarse to fine compiler.

11. The computer-implemented method as recited in claim 10 wherein a coarse to fine dictionary converts one or more coarse technical terms into the common technical terms.

12. The computer-implemented method as recited in claim 9 wherein each network specific model of the plurality of network specific models that has the standard granularity level is converted to a network common model of the plurality of network common models via a standard to fine compiler.

13. The computer-implemented method as recited in claim 12 wherein a standard to fine dictionary converts one or more standard technical terms into the common technical terms.

14. The computer-implemented method as recited in claim 2 wherein the common granularity level is the coarse granularity level.

15. The computer-implemented method as recited in claim 14 wherein each network specific model of the plurality of network specific models that has the standard granularity level is converted to a network common model of the plurality of network common models via a standard to coarse decompiler.

16. The computer-implemented method as recited in claim 14 wherein each network specific model of the plurality of network specific models that has the fine granularity level is converted to a network common model of the plurality of network common models via a fine to coarse decompiler.

17. The computer-implemented method as recited in claim 1 wherein a compiler converts a network specific model of the plurality of network specific models to the common granularity level if a granularity level of the network specific model is coarser than the common granularity level.

18. The computer-implemented method as recited in claim 1 wherein a decompiler converts a network specific model of the plurality of network specific models to the common granularity level if a granularity level of the network specific model is finer than the common granularity level.

19. The computer-implemented method as recited in claim 1 wherein additional network specific models of the plurality of network specific models are converted to network common models and merged into the consolidated model skeleton.

20. A computer-implemented method for consolidating models comprising:
converting a plurality of network specific models into a plurality of network common models wherein the plurality of network common models has a common granularity level and common technical terms wherein a compiler converts a network specific model of the plurality of network specific models to the common granularity level if a granularity level of the network specific model is coarser than the common granularity level, and wherein a decompiler converts a network specific model of the plurality of network specific models to the common granularity level if a granularity level of the network specific model is finer than the common granularity level;
creating a consolidated model skeleton based on the plurality of network common models wherein the consolidated model skeleton includes one or more common functions from each network specific model of the plurality of network specific models; and
connecting unconnected functions in the consolidated model skeleton with a branched function.
